(19) United States
(12) Patent Application Publication
(10) Pub. No.: US 2009/0111591 A1
(43) Pub. Date: Apr. 30, 2009

(54) HYDROSTATIC BENT AXIS DRIVE UNIT HAVING A SYNCHRONIZING JOINT FOR THE ANGULARLY ADJUSTABLE DRIVE CONNECTION OF A CYLINDER BLOCK TO A DRIVESHAFT

(75) Inventor: Howe GRIPP, Kellinghusen (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 12/173,384

(22) Filed: Jul. 15, 2008

(30) Foreign Application Priority Data
Oct. 26, 2007 (DE) 10 2007 051 369.2

(51) Int. Cl. F16D 3/04

(52) U.S. Cl. 464/114

(57) ABSTRACT

The invention relates to a hydrostatic bent axis power unit having a synchronizing joint for the angularly adjustable drive-connection of a cylinder block, which has pistons, to a driveshaft. The synchronizing joint has a shank which is rotatable about its longitudinal axis and thereby defines the joint axis, on the ends of which shank at the drive input and drive output side are provided in each case laterally projecting roller carriers which define a roller axis, which is aligned approximately at right angles to the joint axis, for rollers which are provided on the roller carriers, and against the two ends of which shank bears in each case one connecting pin which is aligned in the direction approximately of the joint axis. In each case one securing element is provided at the two ends of the shank, which securing element both holds the connecting pin in the region of the joint axis in contact against the shank and also prevents the rollers from sliding off the roller carriers.

### BACKGROUND OF THE INVENTION

The invention relates to a hydrostatic bent axis power unit having a synchronizing joint for the angularly adjustable drive connection of a driveshaft to a cylinder block which has pistons, as per the preamble of claim 1.

Bent axis power units have a cylinder drum which is mounted so as to be rotatable about its longitudinal central axis and has cylinder bores distributed over its periphery, in which cylinder bores pistons are movable. Bent axis power units of this type can be used as pumps or motors. In order to adjust the volume flow rate or the suction volume of the unit, the cylinder block can be pivoted about a pivot axis which runs transversely with respect to its rotational axis, as a result of which the longitudinal central axis of the cylinder block forms an adjustable angle with the axis of the driveshaft. The pistons are articulately supported here on the drive flange of the shaft at an adjustable angle. The connection between the cylinder block and driveshaft is produced by means of a synchronizing joint, on the ends of which at the drive input and drive output side are provided in each case laterally projecting roller carriers which define a rotational axis, which runs approximately at right angles to the joint axis, for rollers which are provided on the roller carriers. The synchronizing joint serves to ensure the torque transmission between the shaft and the cylinder block which is at an angle with respect thereto. In normal operation, although the synchronizing joint itself is largely free from forces, high torques can by all means also occur at the synchronizing joint in the event of inhomogeneous loads as are caused as a result of pressure pulses in the supply or in the event of retardation of the cylinder drum or of the driveshaft.

In an axial piston machine of the described bent axis type, the pivot point of the cylinder block with respect to the shaft and that of the synchronizing joint do not coincide. The synchronizing joint is therefore embodied as a joint with which the required longitudinal compensation is provided. For this purpose, the synchronizing joint has a substantially cylindrical shank, at the two ends of which is provided in each case one connecting pin which is aligned in the direction approximately of the joint axis, by means of which connecting pin the synchronizing joint bears under spring force at one side against the cylinder block and at the other side against the driveshaft. Said pressure spring additionally has the task of applying the necessary force for sealing off the rotating cylinder drum with respect to the non-rotating valve segment. This applies in particular to the unpressurized state, for example when the motor is started up. Said spring force must in any case be transmitted by the synchronizing joint. On account of the kinematics during the pivoting of the cylinder drum, it is necessary here for the roller carriers to be designed such that the mobility of the rollers on the roller carriers is ensured.

Bent axis power units of the described type are for example known from the company document Sauer Sundstrand, Schragachsen-Verstellmotoren Baureihe 51 [Bent axis adjusting motors, type series 51], page 5A, December 1992.

The assembly or disassembly of the synchronizing joint is relatively complex because the individual components, in particular rollers and connecting pins, are fixedly positioned in their intended position only in the installed state, and must be provisionally fixed using auxiliary means for assembly. A conventional means is grease which temporarily holds the parts in position and is washed away by surrounding oil when the bent axis power unit is set in operation, but as a result of which the oil and the filter required for cleaning the latter are contaminated.

An aim of the invention is to create an assembly-friendly bent axis power unit.

### SUMMARY OF THE INVENTION

According to the invention, the aim is achieved in an bent axis power unit as per the preamble of claim 1 in that in each case one securing element is provided at the two ends of the shank, which securing element both holds the connecting pin in the region of the joint axis in contact against the shank and also prevents the rollers from sliding off the roller carriers. In this way, it is possible to provide the complete synchronizing joint, which is preferably embodied as a tripod joint, as a modular unit which is easy to handle and to assemble without there being a risk of rollers or pins falling out or of incorrect installation.

In one advantageous refinement of the invention, the connecting pins bear in each case with a spherical head in a recess, which widens in the shape of a funnel, of the shank, so that said connecting pins can freely rotate in operation of the bent axis power unit.

The securing element according to the invention advantageously has a central part which surrounds the joint axis and which holds the spherical head of the respective connecting pin in contact against the shank. The central part of the securing element preferably has a radial recess, by means of which the securing element can be pushed over the connecting pin. Here, the spherical head of the connecting pin is held in contact against the shank because the central part of the securing element tapers conically towards a diameter which is smaller than the diameter of the head of the connecting pin. The securing element and the connecting pin can thereby be fixed in a simple manner to the shank of the synchronizing joint.

The central part of the securing element is preferably embodied in the shape of a funnel, as a conical or spherical layer and follows substantially the contour of the end-size recesses in the shank of the synchronizing joint. In this way, the connecting pin obtains sufficient space in order to perform the necessary pivoting movements.

It is particularly advantageous if the securing element has arms which extend radially with respect to the joint axis and which extend through the inside of the rollers, and the arms of the securing element have, at their free end, a shoulder which prevents the rollers from sliding off the roller carrier. The arms of the securing element are of resilient design and, for the assembly of the rollers, are pressed into longitudinal grooves of the roller carrier, so that the rollers can be pushed over the roller carrier and over the arm, which is pressed into the longitudinal groove, of the securing element. The arm thereafter returns into its starting position and, with the end-side shoulder, prevents the roller from sliding off the roller carrier. At the same time, the central part of the securing element in this way holds the connecting pin in contact against the shank.

The shank with the roller carriers is preferably produced as a cast part or forged part. The securing element is composed of an elastic material which is oil-resistant and abrasion-resistant. Said securing element is preferably produced in an injection molding process from plastic or from metallic material, such as for example spring steel, in a punching or bending process or by means of investment casting by the wax-melting process or by means of metal injection molding.

### BRIEF DESCRIPTION OF THE FIGURES

Further features and advantages of the invention can be gathered from the following description of the figures, in which:

FIG. 1 shows a bent axis power unit according to the invention;

FIG. 2 shows the individual parts of the synchronizing joint;

FIG. 3 shows the shaft body of the synchronizing joint in a perspective and front view;

FIG. 4 shows the securing element;

FIG. 5 shows the connecting pin; and

FIG. 6 shows the synchronizing joint in longitudinal section.

### DETAILED DESCRIPTION OF THE PREFERRED EMBODIMENT

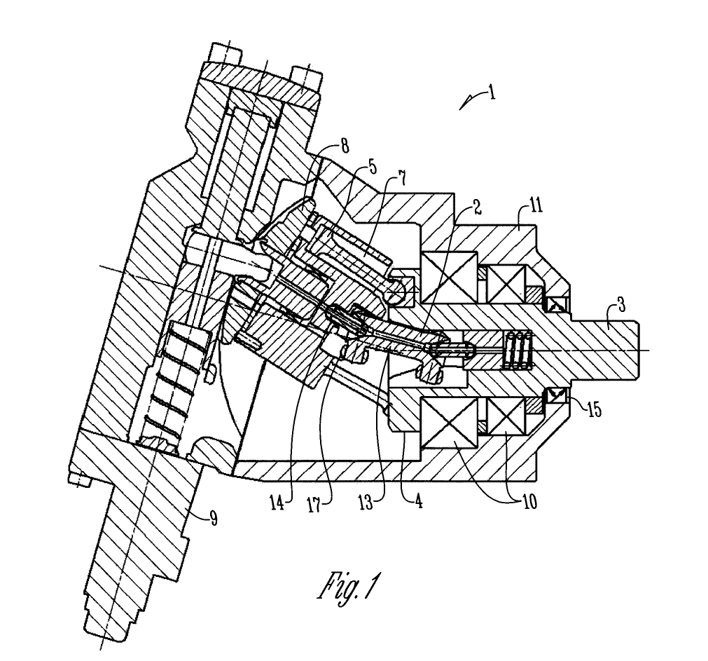

FIG. 1 illustrates a bent axis power unit 1 according to the invention in the form of a hydraulic motor. The unit can fundamentally also be operated as a pump. The power unit 1 has a cylinder block 6 which is mounted so as to be rotatable about its longitudinal central axis and has cylinder bores 7 distributed about its periphery, in which cylinder bores 7 pistons 5 are movable. The cylinder block 6 is mounted in the housing so as to be pivotable about a pivot axis which runs transversely with respect to its rotational axis, so that the longitudinal central axis of the cylinder block 6 forms an adjustable angle with the axis of the driveshaft 3 which itself is fixedly mounted in a bearing 10 in the housing 11. The pistons 5 are articulatedly supported here on the drive flange 4 of the shaft 3 at the set angle. The adjustment takes place by means of an adjusting device 9, by means of which a valve segment 8 which is attached to the cylinder block 6 can be pivoted.

The drive connection between the cylinder block 6 and the driveshaft 3 is produced by means of a synchronizing joint 2 which is embodied as a tripod joint. Said synchronizing joint 2 has a substantially cylindrical shank 13 which is mounted at its ends in each case by means of rollers 17 in the drive flange and in the cylinder block 6, and is supported against these by means of connecting pins 14 under spring loading by a spring 15. Formed in the driveshaft 3 and the cylinder block 6 are raceways for the rollers 17, which raceways are designed such that the synchronizing joint 2 is displaceable in the driveshaft 3 and in the cylinder block 6. For this purpose, the rollers have a spherical outer contour. In this way, length compensation can take place for different pivot angles. The pressure spring 15 is installed in the driveshaft 3. The pressing force of said pressure spring 15 is transmitted to the cylinder block 6.

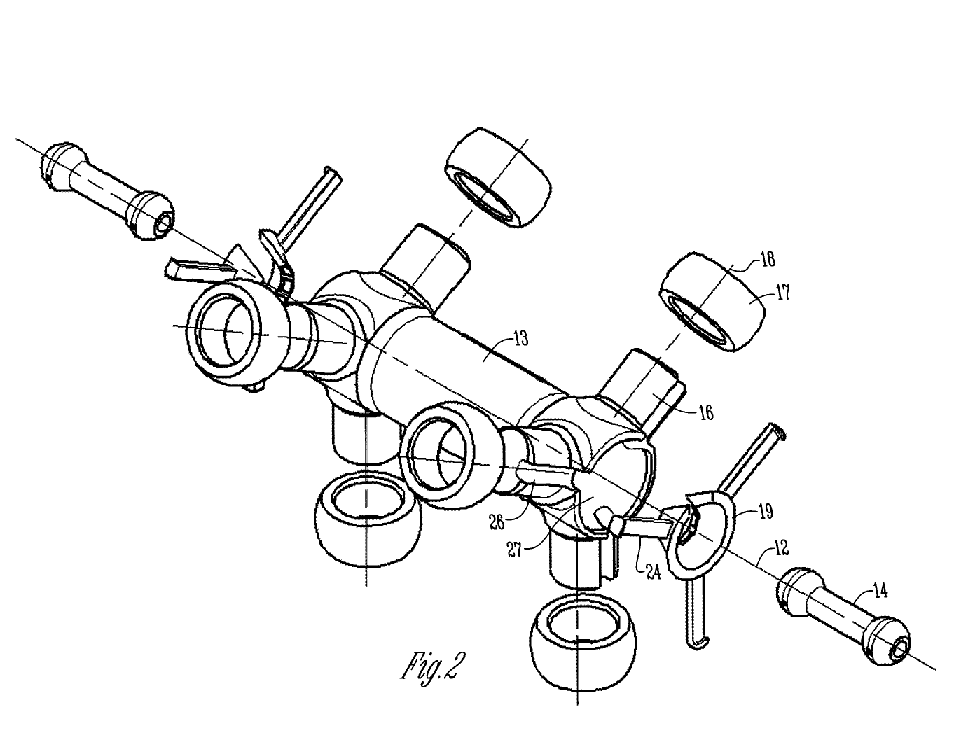

As is illustrated in detail in FIG. 2, the synchronizing joint 2 which is embodied as a tripod joint is composed substantially of two spherical stars and a cylindrical shank 13 which connects the two spherical stars to one another. For this purpose, the shank 13 which is aligned in the direction of the joint axis 12 has in each case three roller carriers 16 at its two ends, which roller carriers 16 in each case define a roller axis 18, which is aligned perpendicular to the joint axis 12, for the rollers 17 by means of which the synchronizing joint 2 is mounted at the one side in the drive flange and at the other side in the cylinder block. The synchronizing joint 2 is supported, under the pressure of the pressure spring which is provided in the drive flange or in the driveshaft, to both sides on the cylinder block and on the driveshaft by means of in each case one connecting pin 14.

The roller carriers 16 are offset with respect to one another by in each case 120°, project perpendicularly from the shank 13 and have in each case one longitudinal groove 26 for holding an arm 24 of the securing element 19. Said securing element 19 serves both to prevent the rollers 17 sliding off the roller carriers 16 and also to hold the connecting pin 14 in contact in the respective spherical or funnel-shaped recess 21 in the end side of the shaft body 13, as described in detail below.

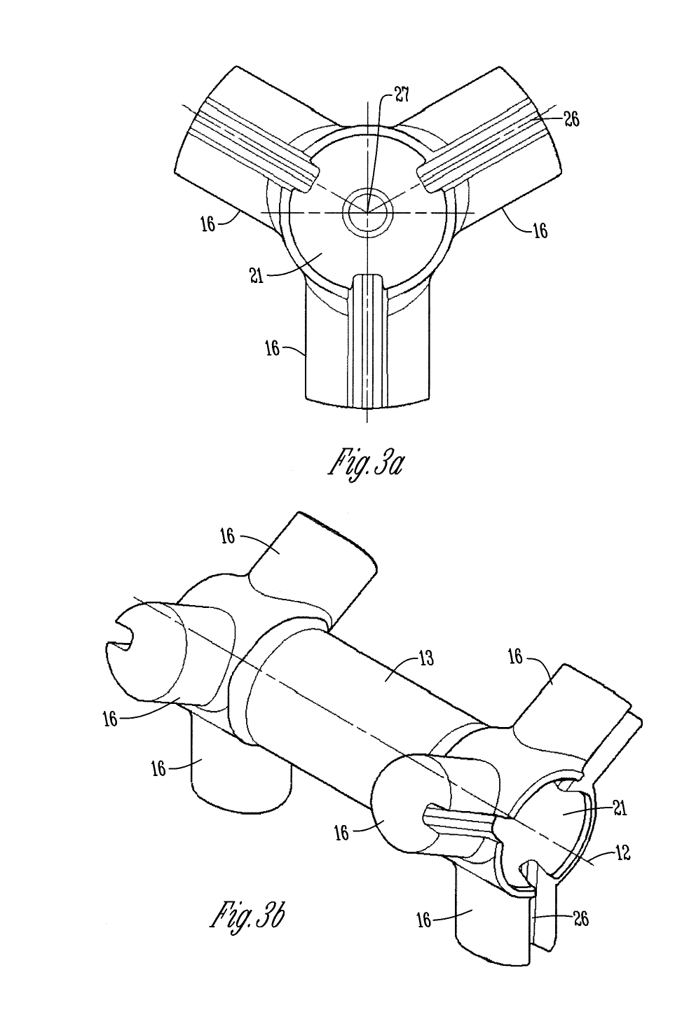

FIG. 3 again illustrates the shank 13, and the roller carriers 16 at both sides, in a front (a) and in a perspective view (b). At the end side, in each case one spherical recess 21 is provided in the shank 13, in which spherical recess 21 bears the connecting pin 14 which rotates freely in operation. A bore 27 which serves for the supply with lubricating oil, extends through the shank 13 along the joint axis 12. The roller carriers 16 have longitudinal grooves 26, which are in each case aligned approximately with the end side of the shank 13, for the arms of the securing element.

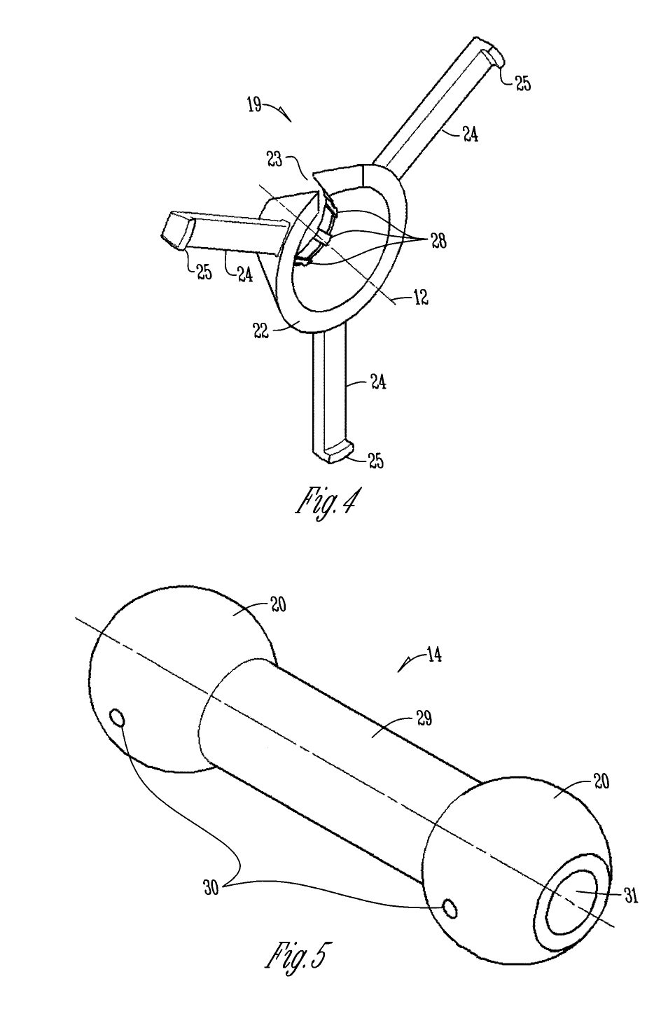

FIG. 4 shows the securing element 19 which is composed of a central part 22 which surrounds the joint axis 12, and three arms 24 which are offset with respect to one another by in each case 120′ and which correspond to the longitudinal grooves on the roller carriers and which have at their end in each case one shoulder 25 which serves for securing the respective roller. The central part 22 is shaped as a funnel-shaped conical layer or as a spherical layer and corresponds to the contour of the recesses on the end sides of the tripod joint. The interior space of the conical or spherical layer offers sufficient space here to ensure the inclinations of the connecting pins which occur in operation of the bent axis power unit. The securing element 19 tapers in the direction of the shank of the tripod joint, so that the head of the connecting pin described below is held in contact against the respective end-side recess during assembly. The central part 22 of the securing element is additionally slotted and thereby has a radial recess 23 through which the connecting pin can be inserted for assembly. The free diameter of the central part in said region corresponds to the diameter of the shank of the connecting pin. Lubricating oil grooves 28 permit an optimum distribution of the lubricating oil in the region around the connecting pin which rotates freely in operation.

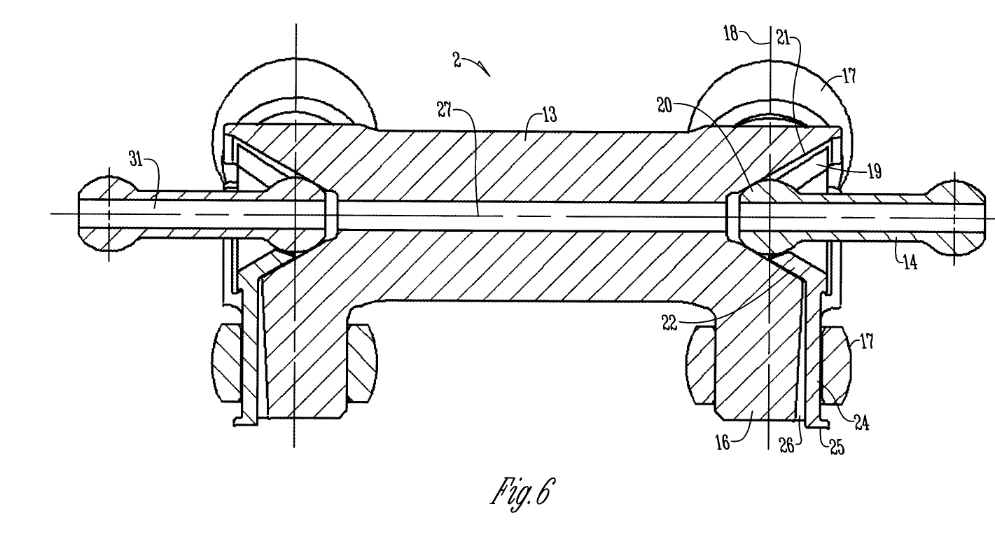

FIG. 5 illustrates the connecting pin 14 according to the invention. Said connecting pin 14 is composed of two spherical heads 20 and a cylindrical connecting shank 29 which has a smaller diameter than the tripod-joint-side head 20, so that the connecting pin 14 can be inserted into the radial recess in the central part of the securing element. Transverse bores in the head 20 of the connecting pin and the longitudinal bore 31 again ensure the transport and the distribution of lubricating oil.

FIG. 6 shows the assembly-ready tripod joint in longitudinal section. Illustrated are the roller carriers 16 which are connected by means of the shank 13 and to which the rollers 17 are attached in a displaceable fashion. Here, the rollers are rotatable about the roller axis 18. At the end side, the shank 13 has, at both sides, in each case one spherical recess 21 in which the spherical head 20 of the connecting pin 14 can freely rotate. The longitudinal bores 27, 31 ensure a sufficient supply with lubricating oil.

At both sides of the shank 13, the two securing elements 19, with their respective central part 22, hold the spherical head 20 of the connecting pin 14 in contact against the recess 21. Here, said central part 22 follows the contour of the recess 21 and widens outwards in the shape of a funnel, so that the connecting pin 14 has the space required for its pivoting movement. The arms 24 of the securing element 19 are assigned to the longitudinal grooves 26 in the roller carriers 16. Here, the longitudinal grooves 26 are designed such that the elastically deformable arms 24 of the securing element 19 can be pressed into the respective longitudinal groove 26 to such an extent that the rollers 17 can be pushed onto the roller carriers 16. The arms 24 thereafter spring back again and, with the end-side shoulders 25, prevent the rollers 17 from sliding off the roller carriers 16. As a result of the arms 24 of the securing element 19 extending through the inside of the rollers 17, the central part 22 of said securing element 19, which hold the head 20 of the connecting pin 14, is also fixed. It is therefore possible during assembly for the synchronizing joint to be handled as a modular unit without there being a risk of rollers or connecting pins sliding out or being incorrectly installed.

The base body of the joint according to the invention can be produced as a cast part or forged part, as illustrated in FIG. 3, with it being possible for the end-side recesses and the grooves for holding the arms of the securing element to be formed already in the blank. The two securing elements are composed of plastic or a metallic material, for example spring steel. A safety element of said type must be sufficiently dimensionally stable to withstand the temperatures which occur in the power unit, and must be abrasion-resistant because any abrasion debris caused by the rotational movement passes directly into the system by means of the surrounding oil. The safety element can for example be produced from plastic which is if appropriate carbon-fibre-reinforced or glass-fibre-reinforced and is encased in friction-reducing PTFE. Injection molding is suitable for the production process. Metallic materials such as steel or bronze are likewise suitable and can be correspondingly processed in a punching and bending process. In any case, the arms of the safety element must be sufficiently elastically deformable in order that the assembly of the synchronizing joint can take place in a simple manner with the preloaded arms of the safety element.

1. Hydrostatic bent axis power unit having a synchronizing joint (2) for the angularly adjustable drive-connection of a cylinder block (6), which has pistons (5), to a driveshaft (3), which synchronizing joint (2) has a shank (13) which is rotatable about its longitudinal axis and thereby defines the joint axis (12), on the ends of which shank (13) at the drive input and drive output side are provided in each case laterally projecting roller carriers (16) which define a roller axis (18), which is aligned approximately at right angles to the joint axis (12), for rollers (17) which are provided on the roller carriers (16), and against the two ends of which shank (13) bears in each case one connecting pin (14) which is aligned in the direction approximately of the joint axis (12) characterized in that in each case one securing element (19) is provided at the two ends of the shank (13), which securing element (19) both holds the connecting pin (14) in the region of the joint axis (12) in contact against the shank (13) and also prevents the rollers (17) from sliding off the roller carriers (16).

2. Hydrostatic bent axis power unit according to claim 1, characterized in that the connecting pins (14) bear in each case with a spherical head (20) in a recess (21), which widens in the shape of a funnel, of the shank (13).

3. Hydrostatic bent axis power unit according to claim 1, characterized in that the securing element (19) has a central part (22) which surrounds the joint axis (12) and which holds the spherical head (20) of the respective connecting pin (14) in contact against the recess (21) of the shank (13).

4. Hydrostatic bent axis power unit according to claim 1, characterized in that the central part (22) of the securing element (19) has a radial recess (23), by means of which the securing element (19) can be pushed over the connecting pin (14).

5. Hydrostatic bent axis power unit according to claim 1, characterized in that the central part (22) of the securing element (19) tapers conically towards the shank (13).

6. Hydrostatic bent axis power unit according to claim 5, characterized in that the central part (22) of the securing element (19) is embodied as a spherical or conical layer.

7. Hydrostatic bent axis power unit according to claim 1, characterized in that the securing element (19) has arms (24) which extend radially with respect to the joint axis (12) and which extend through the inside of the rollers (17).

8. Hydrostatic bent axis power unit according to claim 1, characterized in that the arms (24) of the securing element (19) have, at their free end, a shoulder (25) which prevents the rollers (17) from sliding off the roller carrier (16).

9. Hydrostatic bent axis power unit according to claim 7, characterized in that the arms (24) of the securing element (19) are of resilient design and, for the assembly of the rollers (17) of the synchronizing joint (2), can be pressed into longitudinal grooves (26) of the roller carrier (16).

10. Hydrostatic bent axis power unit according to claim 1, characterized in that the securing element (19) is produced from plastic or a metallic material, in particular from spring steel.

11. Hydrostatic bent axis power unit according to claim 1, characterized in that the synchronizing joint (2) is embodied as a tripod joint.
